(19) United States
(12) Patent Application Publication
(10) Pub. No.: US 2009/0027163 A1
(43) Pub. Date: Jan. 29, 2009

(54) Radio Frequency Identification Tag Holding and Paper Roll Assembly

(76) Inventor: Chia-Ching Su, Sanchong City (TW)

Correspondence Address: HDSL, P.O. BOX 220746, CHANTILLY, VA, 20153-0746, US

(21) Appl. No.: 11/871,235

(22) Filed: Oct. 12, 2007

(30) Foreign Application Priority Data
Jul. 26, 2007 (TW) 096127211

(51) Int. Cl. H04B 7/00

(52) U.S. Cl. 340/10.1

(57) ABSTRACT

A radio frequency identification (RFID) tag holding is for being applied to an object. The object has a receiving space having an opening direction. The RFID tag holding includes a supporting member for fixing in the receiving space. The supporting member has a carrier region for carrying an RFID tag. A normal vector of the carrier region and the opening direction are substantially parallel or form a predetermined acute angle.

### CROSS REFERENCE TO RELATED APPLICATION

The present application claims the benefit of priority to Taiwanese Patent Application No. 096127211, filed on Jul. 26, 2007, the disclosure of which is hereby incorporated herein by reference.

### BACKGROUND

1. Technical Field

The present invention generally relates to RFID technology, and more particularly to an RFID tag holding and a paper roll assembly using the same.

2. Description of the Related Art

Nowadays, in order to facilitate production management and inventory control and track of paper rolls, the RFID technology is employed in the production of the paper rolls. Typically, as disclosed in U.S. Pub. No. 2004/0102870A1 entitled, “System and Method for Tracking Inventory”, an RFID tag is directly attached on an inner sidewall of a tubular core of a paper roll. However, in one aspect, because the paper roll for either industrial or consumer use is relatively bulky and thick, electromagnetic waves are difficult to directly penetrate through the paper roll and therefore the RFID tag could not effectively receive enough electromagnetic energy for information read and write. In another aspect, if the electromagnetic waves are transmitted between the RFID tag and an RFID reader via an opening of the tubular core of the paper roll, electromagnetic wave receiving and transmission directions in the tubular core would be substantially perpendicular to each other in this circumstance. The electromagnetic waves received by the RFID reader or the RFID tag would be unwillingly reduced, probably to the level that causes read errors. Thus, the read and write reliability for the RFID system is seriously degraded.

What is need is a novel RFID tag holding and a paper roll assembly using same, which is able to facilitate an RFID tag carried thereon to effectively receive and transmit electromagnetic waves, whereby read and write reliability is improved.

### BRIEF SUMMARY

The present invention is to provide an RFID tag holding for carrying an RFID tag of an object. The RFID tag holding would effectively improve the read and write reliability of the RFID tag carried thereon.

Furthermore, the present invention is to provide a paper roll assembly. An RFID tag thereof could have an improved read and write reliability due to the use of an RFID tag holding.

An RFID tag holding, in accordance with a preferred embodiment, is configured (i.e., structured and arranged) for being applied to an object. The object has a receiving space. The RFID tag holding comprises a supporting member configured for fixing in the receiving space of the object. The supporting member comprises a carrier region for carrying an RFID tag. A normal vector of the carrier region and an opening direction of the receiving space are substantially parallel or form a predetermined acute angle.

Further preferably, the predetermined acute angle is approximately equal to or less than 45 degrees.

Even further preferably, the RFID tag holding further comprises a tubular body. The tubular body comprises a tube wall. An axial hole extends along an axial direction of the tubular body. The supporting member is fixed on the tube wall, and the supporting member is secured inside the receiving space by the tubular body being fixed on a side wall of the receiving space.

Yet further preferably, an outer surface of the tube wall is a roughened surface, e.g., a sand surface or a grain surface.

Still further preferably, the tube wall of the tubular body has an elongated split formed along the axial direction of the tubular body.

Even still further preferably, the RFID tag holding is made of a non-metal material, e.g., paper, plastic, polylone or sponge.

A paper roll assembly, in accordance with another preferred embodiment, comprises a paper roll having a receiving space, an RFID tag holding, and an RFID tag. The receiving space has an opening direction. The RFID tag holding comprises a supporting member. The supporting member has a carrier region formed thereon. A normal vector of the carrier region and the opening direction of the receiving space are substantially parallel or form a predetermined acute angle.

Further preferably, the predetermined acute angle is approximately equal to or less than 45 degrees.

Even further preferably, the RFID tag holding further comprises a tubular body. The tubular body comprises a tube wall. An axial hole extends along an axial direction of the tubular body. The supporting member is fixed on the tube wall, and the supporting member is secured inside the receiving space by the tubular body being fixed on a side wall of the receiving space.

Yet further preferably, an outer surface of the tube wall is a roughened surface, e.g., a sand surface or a grain surface.

Still further preferably, the tube wall of the tubular body has an elongated split formed along the axial direction of the tubular body.

Even still further preferably, the RFID tag holding is made of a non-metal material, e.g., paper, plastic, polylone or sponge.

Compared with related arts, the RFID tag holding, in accordance with the preferred embodiment, has a carrier region of which a normal vector is substantially parallel with the opening direction of the receiving space of an object (e.g., the paper roll assembly) or forming a predetermined acute angle. When an RFID tag of the object is carried on the carrier region of the RFID tag holding, electromagnetic wave receiving and transmission directions of the RFID tag would be substantially parallel. Furthermore, the roughened outer surface of the tube wall of the tubular body and the elongated split of tube wall make the RFID tag stably attach to the object. The read and write reliability of the RFID system is improved thereby. In addition, a non-metal RFID tag holding effectively prevents itself from direct contact of a conductor (e.g., a metal) so as to avoid efficiency degradation.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic, perspective view of an RFID tag holding, in accordance with a first preferred embodiment, the RFID tag supporting comprising a cylindrical tubular body and a supporting member.

FIG. 2 is a schematic, perspective view of the supporting member of FIG. 1.

FIG. 3 is a schematic, perspective view of another RFID tag holding similar to that of FIG. 1, but further comprising a strengthen member.

FIG. 4 is a schematic, perspective view of still another RFID tag holding similar to that of FIG. 1, but the tubular body being a hollow rectangular parallelepiped.

FIG. 5 is a schematic, perspective view of a supporting member, in accordance with another preferred embodiment.

FIG. 6 is a schematic, perspective view of a paper roll assembly, in accordance with a second preferred embodiment.

FIG. 7 is a schematic, perspective view of another type object, in accordance with a preferred embodiment, the object having a columnar protruding portion and an RFID tag holding of FIG. 1 being sleeved thereon.

### DETAILED DESCRIPTION

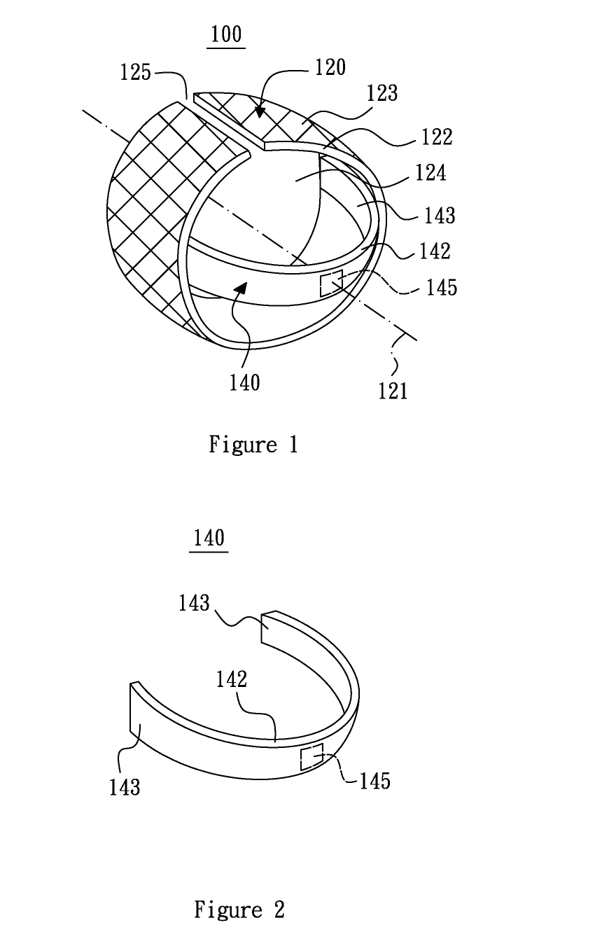

Referring to FIGS. 1 and 2, an RFID tag holding 100, in accordance with a first preferred embodiment, is provided. The RFID tag holding 100 comprises a tubular body 120 and a supporting member 140.

The tubular body 120 has a hollow cylindrical structure, and comprises a tube wall 122. An axial hole 124 extends along an axial direction 121 of the tubular body 120 as indicated by the dotted and dash line in FIG. 1. The tube wall 122 is made of a non-metal material, such as paper, plastic, polylone or sponge. The tube wall 122 is fixed on a side wall of a receiving space of an object (not shown in FIG. 1) or is sleeved on a protruding portion of an object (not shown in FIG. 1). Preferably, an outer surface 123 of the tube wall 122 is a roughened surface, such as a sand surface or a grain surface, if the tube wall 122 is received on the side wall of the receiving space. Alternatively, an inner surface (not labeled) opposite to the outer surface 123 is a roughened surface if the tube wall 122 is sleeved on the protruding portion or a side wall of the receiving space. The roughened surface could effectively increase friction between the tubular body 122 and the object on which the tubular body 122 is fixed or sleeved so that the tubular body 122 may be fixed or sleeved more stably on the object, whereby the read and write efficiency of an RFID tag carried by the RFID tag holding 100 is improved. Further preferably, the tube wall 122 has an elongated split 125 formed thereon so that the tube wall 122 has a C-shaped cross section. The elongated split 125 extends along the axial direction 121 of the tubular body 120. The elongated split 125 renders the tubular body 120 being elastic and therefore the RFID tag holding 100 can be even more stably fixed or sleeved on the object.

The supporting member 140 is suitably fixed on the inner surface of the tube wall 122 as illustrated in FIG. 1 or at an edge of the tube wall 122. The supporting member 140 is made of a non-metal material, such as paper, plastic, polylone or sponge. The supporting member 140 has a carrier region 145 for carrying an RFID tag (not shown in FIG. 1).

Referring to FIG. 2, in the illustrated embodiment, the supporting member 140 comprises a supporting portion 142 and engaging portions 143 located at two ends of the supporting portion 142. The supporting member 140 is fixed on the tube wall 122 by way of the engaging portions 143. The engaging portions 143 could be attached to the tube wall 122 via glue or tenons. The supporting member 140 and the tubular body 120 also can be integrally formed. The supporting portion 142 has an arc-shaped stripe-like structure. The supporting portion 142 has the carrier region 145 formed thereon as indicated by the dotted and dashed area. The carrier region 145 has an arc-shaped surface. A central normal vector thereof and the axial direction 121 of the tubular body 120 are substantially parallel to each other. It is understood that the carrier region 145 may be located at a place of the arc-shaped surface other than the marked area illustrated in FIG. 1 as long as the electromagnetic waves' receiving and transmission directions of the RFID tag carried on the carrier region 145 are substantially parallel. Preferably, an angle between a normal vector of the place and the axial direction 121 is an acute angle approximately equal to or less than 45 degrees.

It is understood that the RFID tag holding 100 may only comprise the supporting member 140 as illustrated in the FIG. 2 without the tubular body 120. The supporting member 140 can be directly secured inside the receiving space of the object, whereby the normal vector of the carrier region 145 and an opening direction of the receiving space are substantially parallel to each other or form an acute angle approximately equal to or less than 45 degrees. Preferably, the supporting member 140 is an elastic member in one embodiment.

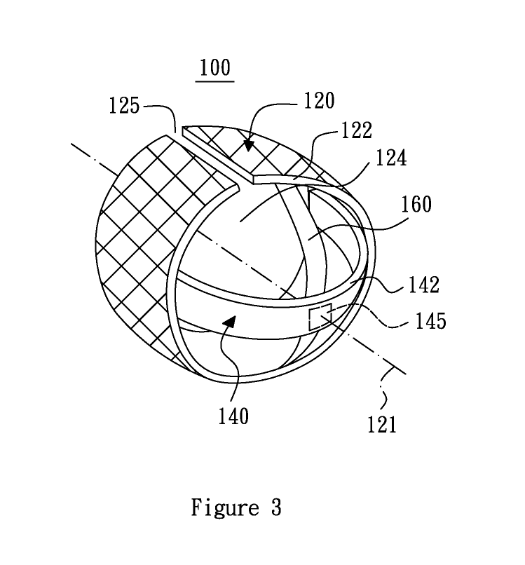

Referring to FIG. 3, in order to further enhance the stability of the supporting member 140, the RFID tag holding 100 further comprises a strengthen member 160. The strengthen member 160 is received in the axial hole 124 and fixed on the tube wall 122 of the tubular body 120. The strengthen member 160 is intersected with the supporting member 140 and supports the supporting member 140 at a side of the supporting member 140 opposite to the carrier region 145. The strengthen member 160 may have a structure similar to that of the supporting member 140. Therefore, the structure of the strengthen member 160 will not be repeated herein.

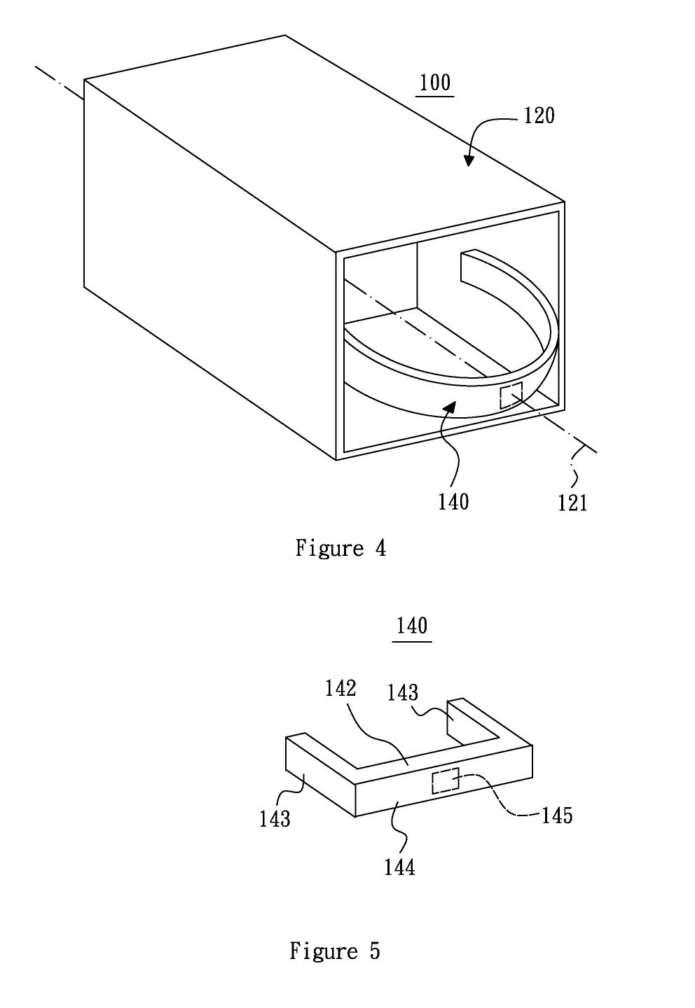

The tubular body 120 is not limited to the hollow cylindrical structure. The structure may be adjusted according to the shape of the receiving space, e.g., a hollow rectangular parallelepiped (as shown in FIG. 4).

Referring to FIG. 5, the supporting member 140 can be a π-shaped structure instead as illustrated in FIG. 5. Correspondingly, the carrier region 145 of the π-shaped supporting member 142 has a flat surface. A normal vector of the flat surface is substantially parallel with the axial direction 121. Therefore, the carrier region 145 can be located at any place of the flat surface. It is understood that the RFID tag holding 100 may only comprise the supporting member 140 in the FIG. 5 without the tubular body 120. The supporting member 140 can be directly fixed inside the receiving space of the object, whereby the normal vector of the carrier region 145 is substantially parallel with the opening direction of the receiving space.

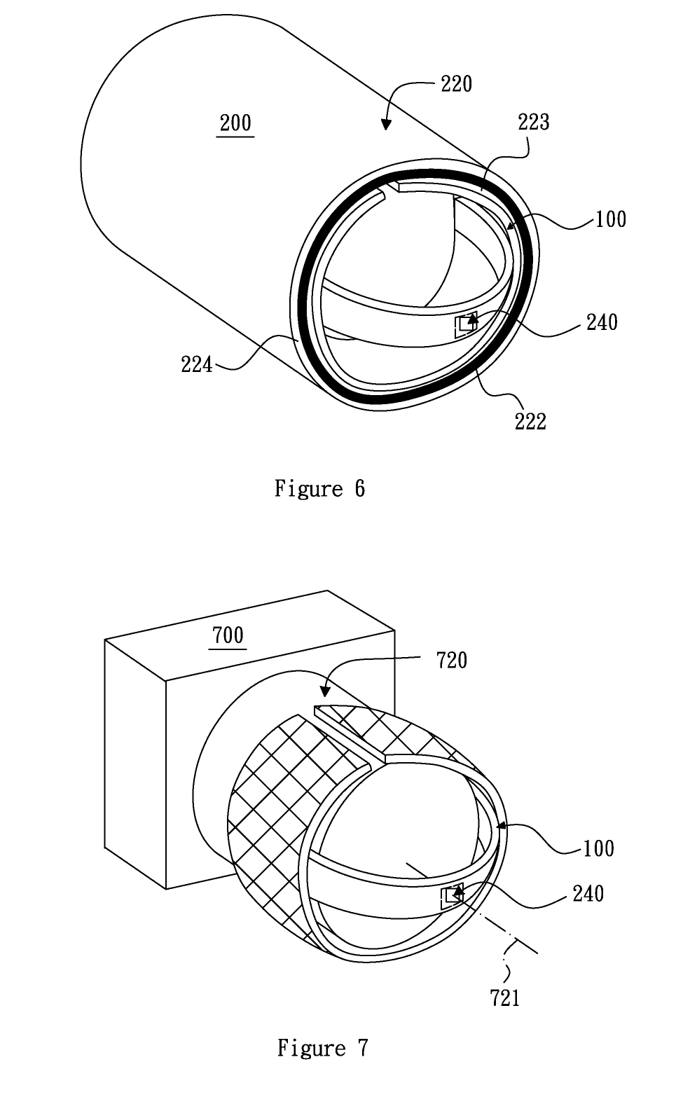

Referring to FIG. 6, a paper roll assembly 200, in accordance with a second preferred embodiment, is provided. The paper roll assembly 200 comprises a paper roll 220, an RFID tag holding 100 as described above, and an RFID tag 240.

The paper roll 220 comprises a tubular core 222 and a paper stock 224 wound around the tubular core 222. The tubular core 222 generally has a hollow-cylindrical structure. The tubular core 222 has a receiving space 223.

The RFID tag holding 100 is received in the receiving space 223. The carrier region 145 has a normal vector is substantially parallel with an opening direction of the receiving space 223, i.e., generally an axial direction of the receiving space 223, or forms a predetermined acute angle with the opening direction of the receiving space 223. It is preferred that the predetermined acute angle is approximately equal to or less than 45 degrees. The RFID tag holding 100 is firmly fixed in the receiving space 223 via the tube wall 122 of the tubular body 12 contacting with an inner surface of the tubular core 222 (i.e., a side wall of the receiving space 223).

The RFID tag 240 can be fixed on the carrier region 145 by glue or a film. The RFID tag 240 typically comprises a chip and an antenna. The chip is electrically coupled to the antenna. The RFID tag 240 can be active or passive, and configured to operate in one of several different frequency bands such as high frequency (HF, typically 13.56 MHz), low frequency (LF, typically 125 KHz), ultra high frequency (UHF, typically 850-960 MHz), and micro-wave band (typically 2.45 GHz and/or 5.8 GHz).

In conclusion, the normal vector of the carrier region 145 of the RFID tag holding 100 is substantially parallel with the opening direction of the receiving space of an object or forms a predetermined acute angle with the opening direction of the receiving space. Therefore, when an RFID tag is carried on the carrier region 145 of the RFID tag holding 100, the read and write reliability of the RFID system is improved. Furthermore, the roughened outer surface 123 of the tube wall 122 of the tubular body 120 and the elongated split 125 of tube wall 122 make the RFID tag holding 100 being firmly fixed on the receiving space. In addition, the non-metal RFID tag holding 100 effectively prevents the RFID tag from direct contact of a conductor (e.g., a metal) so as to avoid efficiency degradation.

The above preferred embodiment only gives an example of applying the RFID tag holding 100 into the paper roll 220. It is understood to one skilled in the art that the RFID tag holding 100 can be applicable to other objects. For example, an object 700 having a columnar protruding portion 720 as shown in FIG. 7 will do. The columnar protruding portion 720 allows the RFID tag holding 100 to be sleeved thereon. The axial direction of the tubular body 120 of the RFID tag holding 100 is substantially parallel with a central axial direction 721 of the columnar protruding portion 720. The columnar protruding portion 720 may have other shapes different from the one in FIG. 7 for the RFID tag holding 100 to be sleeved thereon.

The above description is given by way of example. Given the above disclosure, one skilled in the art could devise variations that are within the scope and spirit of the invention disclosed herein, comprising configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An RFID tag holding for being applied to an object, the object having a receiving space, the RFID tag holding comprising:
a supporting member for fixing in the receiving space, the supporting member comprising a carrier region for carrying an RFID tag, a normal vector of the carrier region and an opening direction of the receiving space being substantially parallel or forming a predetermined acute angle.

2. The RFID tag holding according to claim 1, wherein the predetermined acute angle is approximately equal to or less than 45 degrees.

3. The RFID tag holding according to claim 1, further comprising a tubular body, wherein the tubular body comprises a tube wall, an axial hole extends along an axial direction of the tubular body, the supporting member is fixed on the tube wall, and the supporting member is secured inside the receiving space by the tubular body being fixed on a side wall of the receiving space.

4. The RFID tag holding according to claim 3, wherein the supporting member is fixed on an inner surface or an edge of the tubular body.

5. The RFID tag holding according to claim 3, wherein an outer surface of the tube wall of the tubular body is a sand surface or a grain surface.

6. The RFID tag holding according to claim 3, wherein the tube wall of the tubular body has an elongated split formed along the axial direction of the tubular body.

7. The RFID tag holding according to claim 3, wherein the RFID tag holding is made of a non-metal material selected from the group of paper, plastic, polylone and sponge.

8. The RFID tag holding according to claim 3, wherein the tubular body is a hollow cylindrical structure or a hollow rectangular parallelepiped.

9. The RFID tag holding according to claim 3, wherein the supporting member is received in the axial hole of the tubular body, the supporting member comprises a supporting portion and engaging portions located at two ends of the supporting portion, the supporting member is fixed on the tube wall of the tubular body via the engaging portions, and the carrier region is formed on the supporting portion.

10. The RFID tag holding according to claim 9, further comprising a strengthen member, wherein the strengthen member is received in the axial hole and secured on the tube wall of the tubular body, and the strengthen member is intersected with the supporting member to support the supporting portion.

11. A paper roll assembly, comprising:
a paper roll having a receiving space formed therein, the receiving space having an opening direction;
an RFID tag holding comprising a supporting member fixed in the receiving space, the supporting member comprising a carrier region, a normal vector of the carrier region and the opening direction of the receiving being substantially parallel or forming a predetermined acute angle; and
an RFID tag carried on the carrier region of the supporting member.

12. The paper roll assembly according to claim 11, wherein the predetermined acute angle is approximately equal to or less than 45 degrees.

13. The paper roll assembly according to claim 11, wherein the RFID tag holding further comprises a tubular body, the tubular body comprises a tube wall, an axial hole extends along an axial direction of the tubular body, the supporting member is fixed on the tube wall, and the supporting member is secured inside the receiving space by the tubular body being fixed on a side wall of the receiving space.

14. The paper roll assembly according to claim 13, wherein the supporting member is fixed on an inner surface or an edge of the tubular body.

15. The paper roll assembly according to claim 13, wherein an outer surface of the tube wall of the tubular body is a sand surface or a grain surface, the tube wall has an elongated split formed along the axial direction of the tubular body.

16. The paper roll assembly according to claim 13, wherein the RFID tag holding is made of a non-metal material selected from the group of paper, plastic, polylone and sponge.

17. The paper roll assembly according to claim 13, wherein the tubular body is a hollow cylindrical structure or a hollow rectangular parallelepiped.

18. The paper roll assembly according to claim 13, wherein the supporting member is received in the axial hole of the tubular body.

19. The paper roll assembly according to claim 13, wherein the supporting member comprises a supporting portion and engaging portions located at two ends of the supporting portion, the supporting member is fixed on the tube wall via the engaging portions, the carrier region is formed on the supporting portion.

20. The paper roll assembly according to claim 11, wherein the paper roll comprises a tubular core and a paper stock wound around the tubular core, the receiving space is an inner space of the tubular core.
